(19) United States
(12) Patent Application Publication
(10) Pub. No.: US 2005/0072812 A1
(43) Pub. Date: Apr. 7, 2005

(54) Dischargers for powders

(76) Inventor: David Stuart Dick, Manchester (GB)

Correspondence Address: ADAM EVANS, P.A.;(formerly Adams, Schwartz & Evans, P.A.), 2180 TWO WACHOVIA CENTER, CHARLOTTE, NC, 28282, US

(21) Appl. No.: 10/494,129

(22) PCT Filed: Oct. 28, 2002
(86) PCT No.: PCT/GB02/04859

(30) Foreign Application Priority Data
Nov. 1, 2001 (GB) 0126248.4

(51) Int. Cl. B67C 11/00

(52) U.S. Cl. 222/460

(57) ABSTRACT

There is disclosed a discharger (100) for a powder, the discharger comprising a hopper (102) and an outlet (8), the hopper comprising a discharging surface (5) over which, in use, a powder flows, and means (14, 15) for lowering the angle of internal friction of the powder or for lowering the angle of sliding friction between the powder and the discharger surface, wherein the discharging surface comprises surfaces at least two angles that are progressively shallower towards the outlet and in which a steeper part of the discharging surface in use is steeper than 40° from the horizontal. A method of use of such a discharger is also disclosed.

### FIELD OF THE INVENTION

The present invention relates to dischargers for powders.

In particular, but without limitation, the present invention is relevant to the field of storage bins for powders, such as wheat flour.

### BACKGROUND TO THE INVENTION

Dischargers for powders generally comprise a hopper and an outlet.

Several aspects must be considered in the design of hoppers. First, the product in the hopper must not form an arch, which interrupts the flow of the product. If and when the arch collapses the product will often surge from the hopper. It is well known that arching can be eliminated if the opening at the outlet of the hopper is large enough. For a right circular conical hopper, the critical gravity flow-arching dimension for a particular material is designated as Bc. As will be seen below, the present invention permits the use of a discharge opening that is only a fraction of Bc.

A second consideration in the design of hoppers is that the hopper walls must be steep and smooth enough to force the product to slide on them whenever any is withdrawn from the outlet. If the hopper walls are not steep enough the product will form a very steep sided flow channel within otherwise stagnant material, which results in many undesirable consequences. For a hopper having the shape of a right circular cone, the largest semi-apex angle at which mass flow will occur for a particular product and hopper wall condition is denoted by θ_{c}. In general, there is no advantage to making the walls of a hopper steeper than the angle required for mass flow. In fact the theory teaches that there is an optimum slope angle (for mass flow). Making the slope steeper, as well as less steep, decreases the flowability of the hopper according to this theory.

“Mass flow” is defined and the method for the determination of a slope angle required for mass flow is set out in “Storage and Flow of Solids” by Andrew W Jenike; Bulletin 123 of Utah Engineering Experiment Station. This also provides the method for determining the critical arching dimensions Bc and Bp.

A design that is used occasionally when the product being handled is a fine, dry powder with low permeability consists of a right circular conical hopper with a plenum chamber covered by a permeable membrane. Air blown into the plenum chamber passes through the permeable membrane and fluidises the powder, removing its ability to form an arch. The slope of the right circular conical hopper is not normally as steep as θ_{c} since the fluidised powder flows like a fluid rather than a pulverulent solid.

The advantages of ‘plane flow’ as opposed to ‘conical flow’, are well known. Plane flow occurs when a particulate solid flows through a ‘slotted’ hopper outlet with the length of the slot being at least three times greater than the width. The theory teaches that the critical gravity flow arching dimension for a slot outlet (Bp) is approximately half that for a right circular conical hopper outlet (Bc). In addition, the critical semi-apex hopper angle at the side of a slot (θₚ) is approximately 10° to 12° larger than the semi-apex angle for a right circular cone (θ_{c}). In spite of the advantages of plane flow, it is not often used in practice because the problem of collecting the product below the slot outlet can be relatively complex.

A further consideration in the design of hoppers is the optimisation of the geometry of the hopper within the constraints described above. Normally, in most applications it is preferred to use, for a given volume, a hopper that is shortest in height.

A design that has been used to create a plane flow pattern makes use of a relatively narrow strip of permeable membrane, rather than a right circular truncated cone, above a plenum chamber. The strip, whose width is set by Bp, the gravity flow-arching dimension of the powder for plane flow, has a length greater than three times the width of the strip. The slope of the membrane is normally less than θₚ. At its lowest point on the centreline, the strip has an outlet, which also contains air jets. In such designs it is necessary to divide the plenum chamber into airtight sections so that different amounts of air can be blown into different regions of the bin.

One of the reasons collecting material under a slot is complex is that the product must shear in a certain way and change its direction of flow. Development of the correct shear planes and the forces required to change the direction of flow can be difficult to achieve.

### SUMMARY OF THE INVENTION

According to the present invention in a first aspect, there is provided a discharger for a powder, the discharger comprising a hopper and an outlet, the hopper comprising a discharging surface over which, in use, a powder flows, and means for lowering the angle of internal friction of the powder or for lowering the angle of sliding friction between the powder and the discharger surface, wherein the discharging surface comprises surfaces at at least two angles that are progressively shallower towards the outlet and in which a steeper part of the discharging surface in use is steeper than 400 from the horizontal.

By reducing the angle of internal friction or the angle of sliding friction and providing a sloped wall in the range of angles specified, surprisingly it has been found that many of the problems referred to above are done away with and a relatively small outlet can be used. In this way the mass flow angle is less dependent on powder properties and a reliable flow regime can be produced from such an arrangement.

Suitably, the discharger surface is steeper than 45°, and more suitably steeper than 500 from the horizontal.

Suitably, the discharger surface slope is steeper than 600 from the horizontal.

Suitably, the width of the discharger surface is less than 30% of its length.

Suitably, the discharger surface is curved from the back to the outlet.

Suitably, there is provided means for lowering the angle of internal friction and for lowering the angle of sliding friction between the powder and the discharger surface, in which means the discharger surface comprises a gas permeable membrane and means for passing a gas through the gas permeable membrane.

Suitably, the gas permeable member comprises a flexible bag.

Suitably, means is provided to pass a gas through a powder from beneath. Suitably, the discharger is adapted to pass gas through a powder adjacent to the outlet.

Suitably, there is provided means for lowering the angle of internal friction and for lowering the angle of sliding friction between the powder and the discharger surface, which comprises a vibrator for vibrating the discharger surface.

Suitably, the discharger further comprises a front wall adjacent the outlet, which front wall slopes inwardly towards the hopper as it extends to the outlet.

Suitably, the inward slope is substantially 100 from the vertical.

Suitably, the discharger surface is curved across the discharger surface.

Suitably, the curve is generally a U-shape.

Suitably, the discharger comprises side walls at least one of which diverges as it approaches the outlet.

Suitably, at least one internal ridge is provided extending from a side wall.

Suitably, at least one ridge extends in a direction toward the outlet.

Suitably, the outlet is at the side of the discharger. In a generally rectangular shaped discharger a side will be on a long edge.

According to the present invention of a second aspect, there is provided a method of use of a discharger according to the first aspect of the invention, the method comprising discharging a powder through the outlet.

It has been found that in dischargers according to preferred embodiments of the present invention increasing the slope of a hopper in one region beyond 400 takes it beyond the critical angle required for mass flow, but improves the flowability of the hopper. Further, a steep portion of the hopper, combined with an optimised hopper layout, occupies less headroom than would be required for a conventional mass flow hopper design, especially when the angle of sliding friction is high. In preferred embodiments, this hopper layout improves the flowability of the hopper to the extent that the outlet size need only be a small fraction of Bc, the critical gravity flow arching dimension of a right circular conical hopper. The flow through small outlet sizes is a significant advantage when the powder has cohesive strength and also when the control of flow rate is important such as in dispensing pharmaceutical powders or measuring out food products and ingredients.

With preferred embodiments of the present invention, one hopper design will reliably handle powders with a very wide range of flow properties. The choice of hopper width and outlet size will be based more on the required flow rate and accuracy of control than on the critical arching dimensions.

### BRIEF DESCRIPTION OF THE DRAWINGS

The present invention will now be described by way of example only, with reference to the drawings that follow; in which:

FIG. 1 is a plan view of a discharger according to a first embodiment of the present invention.

FIG. 2 is a perspective view of the discharger in FIG. 1.

FIG. 3 is a front view of the discharger of FIGS. 1 and 2.

FIG. 4 is a side view of the discharger of FIGS. 1-3.

FIG. 5 is a part-sectional expanded view on the line A-A in FIG. 4.

FIG. 6 is a plan view of a permeable membrane bag for use with the present invention.

FIG. 7 is a perspective view of the bag of FIG. 6.

FIG. 8 is a side view of the bag of FIGS. 6 and 7.

FIG. 9 is a plan view of a discharger according to a second embodiment of the present invention.

FIG. 10 is a perspective view of the discharger of FIG. 9.

FIG. 11 is a front view of the discharger of FIGS. 9 and 10.

FIG. 12 is a side view of the discharger of FIGS. 9-11.

FIG. 13 is an enlarged, partly sectional view on B-B in FIG. 12.

FIG. 14 is a sectional side elevation of a discharger according to a third embodiment of the present invention.

FIG. 15 is an enlarged, sectional view on the line C-C in FIG. 14.

FIG. 16 is a sectional view on the line D-D in FIG. 15.

FIG. 17 is an enlarged partly sectional view of a discharge outlet.

FIG. 18 is a perspective view of an embodiment of the present invention in use with a flexible intermediate bulk container.

### DETAILED DESCRIPTION OF THE PREFERRED EMBODIMENTS

In FIGS. 1-4 of the drawings that follow, a first embodiment of the present invention comprises a discharger 100 having a hopper 102 and an outlet 8. The hopper 102 comprises an upper section 1 and a lower section 2. Upper section 1 can be added to lower section 2 if required. The upper section 1 will ordinarily be required when the discharger 100 is used as part of a bin, but may not be required in the form shown if the lower section is used as part of a flexible walled storage container or other type of process equipment. Lower section 2 of hopper 102 is of a rectangular box shape with rounded ends and comprises side walls 3, an end wall 4 and a discharger surface 5 as a lower wall defining a graduated curved surface with, in the normal operating orientation shown, a steep section 6 and a shallow section 7 at the lower end thereof, the latter extending to a discharger outlet B. Upper section 1 of hopper 102 includes end walls 9 that diverge downwardly.

The sections 6 and 7 together comprise the discharger surface 5 on which a powder in the hopper may slide. The discharger surface 5 is the non-vertical section before end wall 9. The discharger surface 5 has a curved shape from steep section 6, progressively becoming a shallower one to shallow section 7. The distinction between the two sections 6, 7 is somewhat arbitrary, but useful for explaining operation of the present invention.

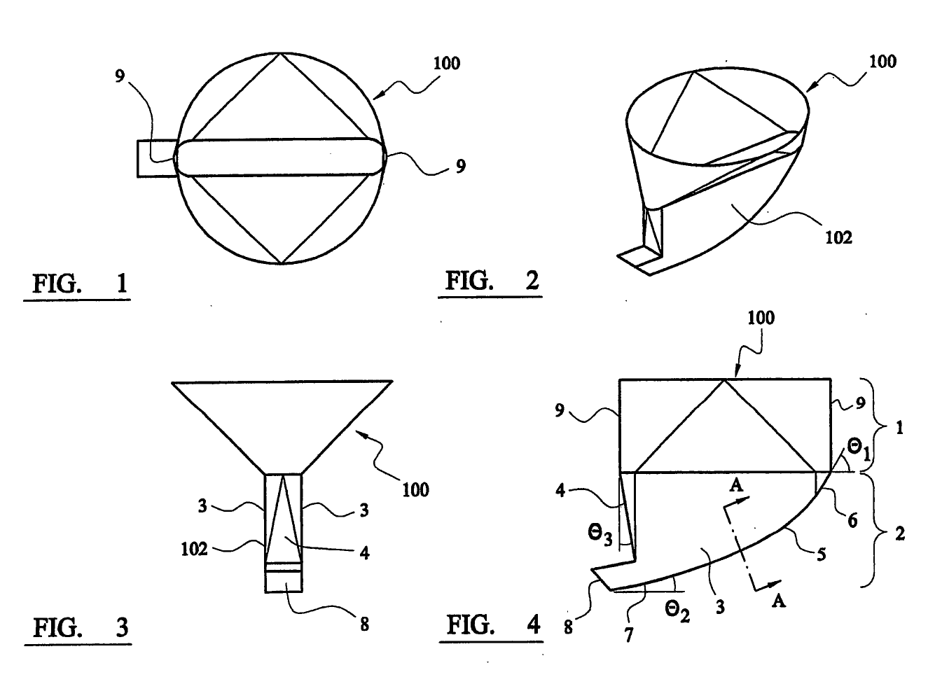

The sidewalls 3 of the lower section 2 are shown as vertical and parallel from back to front in FIGS. 1-4 and 9-12 but they may diverge upwardly. The front wall 4 may be vertical or near vertical. In the preferred embodiment the front wall is sloping inward (toward the centre of the discharger) approximately 10° from vertical. This angle is shown as θ₃ in FIG. 4. In this configuration, the front wall forms a transition shape from the rounded shape at the top to a square shape at the bottom of the front wall 4. The back and lower edges of the box are combined to form the lower wall 5. The end of steep section 6 of the discharger surface 5 is steeper than the angle θₚ and normally greater than 40° from the horizontal. Ordinarily, the angle of the lower section 7 of the discharger surface 5 is between 10° and 15° from the horizontal. This angle is shown as θ₂ in FIG. 1. The curved shape of discharger surface 5 leads into the outlet 8 of the discharger, which projects beyond the front wall 4 by a horizontal distance approximately equal in magnitude to the vertical distance from the bottom of the front wall to the ski-jump shaped surface. The angle of the end of lower section 7 may be steeper than θ₂.

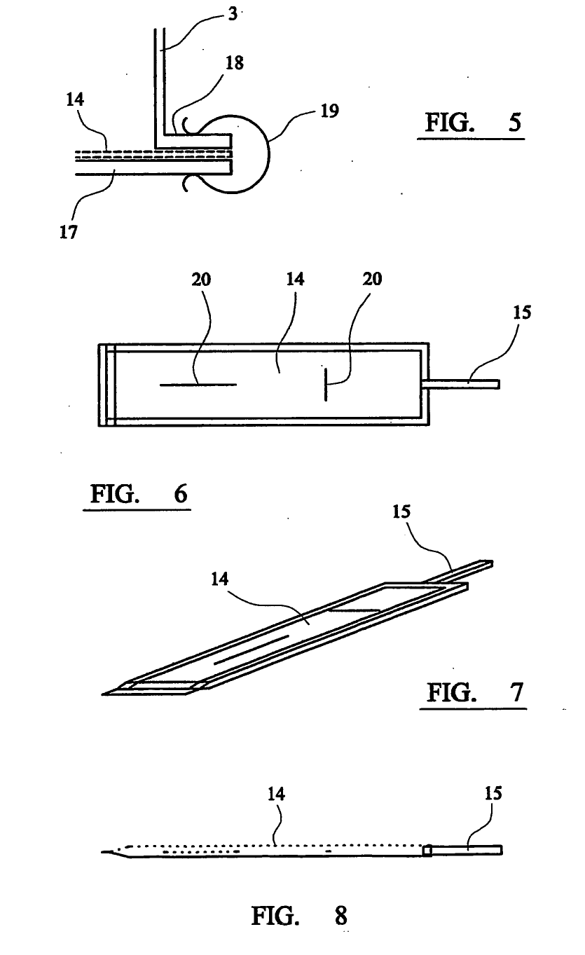

Referring specifically to FIGS. 5-8 of the drawings that follow the flexible bag 14 consists of a flexible air permeable membrane, such as woven polyester, attached with an airtight attachment, such as glue, to a lower skin around its edges, incorporating a nozzle 15 so that air or gas may be blown into the space between the two skins. In some applications the upper and lower skins of the bag are attached together along lines 20 by means of glue or stitching, to minimise the deflection of the membrane during operation. The discharger surface carries a gas (preferably air) permeable membrane in the form of a bag 14. (This arrangement is particularly useful when the membrane must be changed or washed regularly as is the case when handling pharmaceutical and food products where cross-contamination must be avoided.

With the curved shape of the discharger surface and the effect of gravity pushing the powder along the full length of the discharger surface it is not necessary to have sections in the plenum chamber. One air pressure giving an equal flow of air through every section of the permeable membrane is sufficient to cause the powder to flow.

In the embodiment shown in FIGS. 1-5, the bag 14 rests on the curved discharger surface 5 and is held in place between flanges 18 at the lower edge of the sidewalls 3 of the box and a plate 17 shaped to fit snugly to the shape of flanges. The method of holding the plate to the flanges is spring clips 19 but any quick release clamp or other suitable attachment may be used. The spring clips are not shown in FIGS. 1-4, for clarity.

The flowability of the hopper is improved by having a downward divergence of the end walls 9 of the upper section as shown in FIGS. 1, 4, 9 and 12.

This first embodiment is used when handling powders with low permeability, which can be conditioned by blowing air into the mass of powder. In the region of the outlet where the powder has an exposed, unconfined surface, a relatively low flow of air (or gas) substantially removes the angle of internal friction from the powder in the outlet region, allowing it to flow. This also removes the powder's cohesive strength—the property that gives it the ability to form an arch, so that it flows through the outlet. In addition, the air or gas flow through the permeable membrane lowers the angle of sliding friction between the powder and the discharger surface. With the resisting forces due to friction substantially removed, gravity acting on the powder, especially in the steep section of the discharger surface, pushes the layer of powder in the region immediately above the shaped sliding surface toward the outlet.

The amount of air required to move the powder is relatively low. This combined with the small area of permeable membrane relative to the volume of powder being moved leaves the powder in a ‘conditioned’ state rather than fluidised. This is an advantage since a fluidised powder can be difficult to handle and its low bulk density makes it difficult to pack.

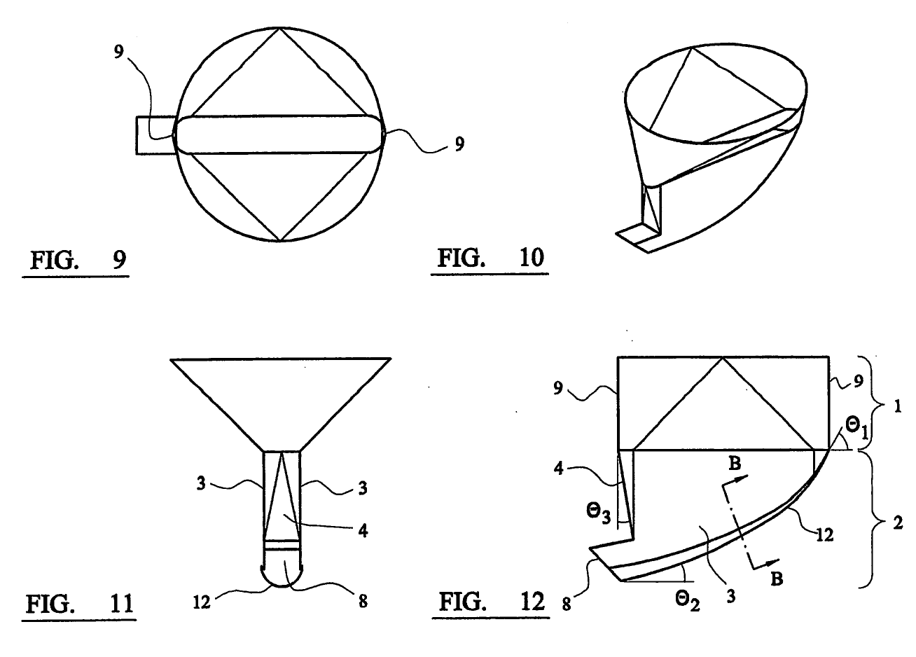

Referring to FIGS. 9-13 of the drawings that follow, a second embodiment of the present invention is shown. Like reference numerals are used for components similar to those in the FIGS. 1-8 embodiment. In this second embodiment lower wall 12 is supported from the lower section 2 by springs 11 (see FIG. 13) or other suitable resilient connectors so that the lower wall 12 may be vibrated. An electromagnetic vibrator (not shown), or other method common in the industry will normally apply the vibrations. The vibrator, its method of attachment to the lower wall and the attachment springs are not shown in FIGS. 9-12, for clarity.

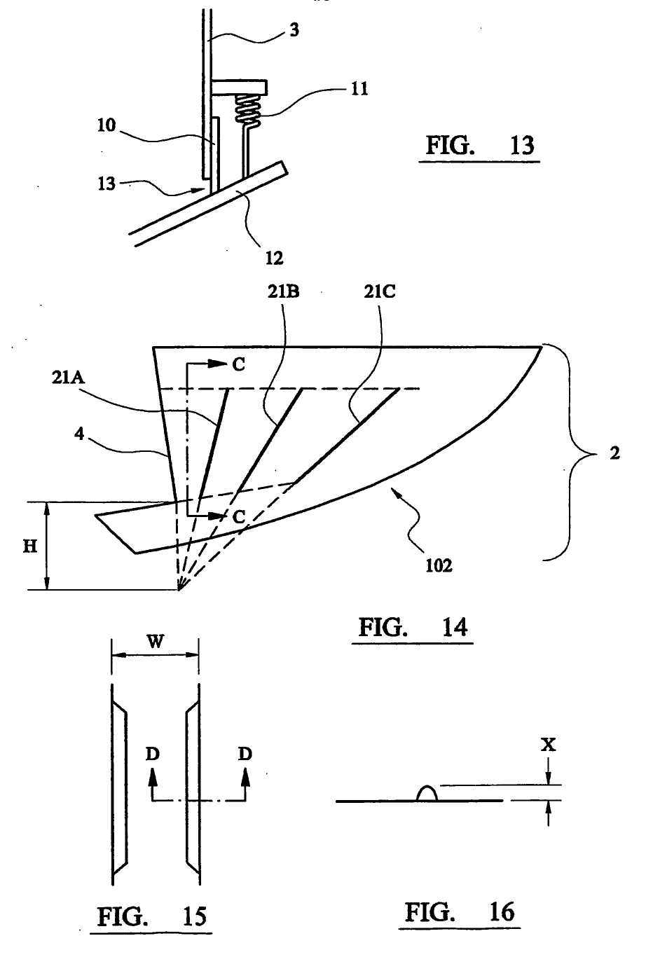

In the second embodiment of FIGS. 9-13, the lower wall 12 is shown as curved, with a flattened U-shape, in its cross-section (see FIG. 11) i.e. across the discharger surface. Experience has shown that this tends to direct the flow toward the centreline of the sliding surface and minimises the tendency of the powder to squeeze between the sidewall and the vibrating surface during operation.

As shown in FIG. 13, an additional flexible strip 10 is shown mounted to the sidewall to seal the necessary gap 13 between the sidewalls 3 and the vibrating surface 12. The side walls 3 are shown as parallel to one another in plan in FIGS. 9-12 but they may diverge from the back to the outlet to further relieve the confining pressures on the powder as it flows down the discharger surface 5.

This second embodiment will be used when handling powders that cannot be conditioned by blowing air into the mass if, for example the permeability of the powder is too high. Both the removal of the angle of repose of the powder in the region of the outlet and the reduction of the angle of sliding friction between the powder and the discharger surface are achieved by vibrating the discharger surface. These vibrations do not compact the powder, which is allowed to expand as it flows. In some applications it may not be necessary to vibrate the whole surface if the powder will slide on the steep surface anyway.

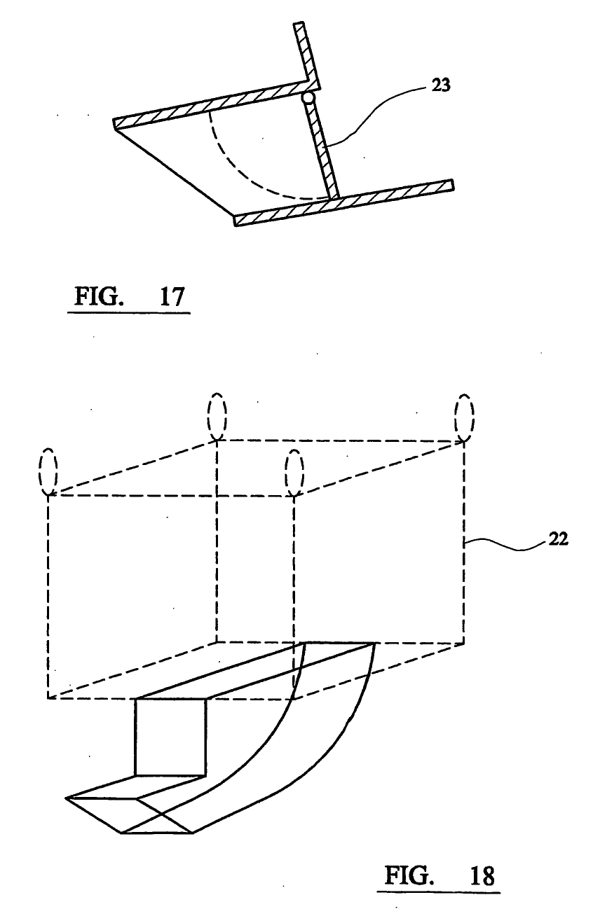

Referring to FIGS. 14-16 of the drawings that follow a modification of the first and second embodiments is shown. In some applications it may be difficult to create a uniform flow along the length of the curved discharger surface 5 or 12. In this embodiment three equally spaced internal ridges 21A, 21B, 21C are provided in the hopper 102. The ridges 21 are located on the side walls 3 of lower section 2. The ridges 21 project out from the side wall 3 a distance X, approximately 10% of the width W of the lower section. There may be more or fewer ridges in different applications. In a preferred embodiment, each ridge extends from a line drawn, parallel to the discharger surface 5 at its lower end (θ₂ from horizontal), from the lower edge of the front wall 4 to a line drawn horizontally from a point three quarters of the distance up the lower section 2, measured from the lower edge of the front wall 4. The ridges are fixed to the side walls on lines drawn radially from a point vertically below the lower edge of the front wall a distance H, which is approximately twice the distance from the lower edge of the front wall 4 to the discharger surface 5. It has been found that these ridges improve the uniformity of flow along the discharger surface 5.

FIG. 17 shows a valve 23 located in the discharger outlet 8 to control the flow rate of powder and seal the discharger when it is not in use or while it is being filled. The valve 23 is used in addition to other methods of controlling the flow rate of powder from the hopper, such as varying the amount of air being blown through the permeable membrane or varying the frequency and amplitude of vibrations.

In FIG. 18 the lower section 2 of the discharger is shown attached to a flexible intermediate bulk container (FIBC) 22. The FIBC is shown as transparent in FIG. 18, for clarity.

Other angles of the steep section that can be advantageous are more than 45°, 50° and 60° from the horizontal.

Dischargers of the type described herein are ordinarily fabricated primarily of sheet metal such as galvanised or stainless steel. However, the present invention is not limited to any particular material and may in some circumstances be made of plastic and may even be flexible rather than rigid.

Thus, preferred embodiments of the present invention permit the use of a discharge opening that is only a fraction of Bc.

Thus, preferred embodiments of the present invention that incorporate a mechanism to provide dischargers that temporarily alter the powder's flow properties. The shape of a special sliding surface allows gravity to cause the powder to flow through an outlet significantly smaller than would be possible with other hopper shapes and with less vertical headroom than existing designs especially when friction angles are high.

At the shallow end of the discharger surface, the powder properties are temporarily altered so that its angle of internal friction or angle of repose is reduced. The powder flows readily through the outlet even if it is substantially smaller than the theoretical minimum outlet size Bc (or Bp). In addition, the angle of sliding friction between the powder and the discharger surface is temporarily reduced to a low value. Gravity acting on the powder at the steep end of the discharger surface provides the moving force that makes the powder flow. The higher the vertical forces acting on the powder at the top of the discharger surface, the better the flow conditions in the hopper. Both of these objectives are achieved in the first embodiment by the air or gas flowing through the permeable membrane into the powder and in the second embodiment by vibrating the discharger sliding surface.

In other hoppers such as a right circular conical mass flow hopper, higher forces than gravity acting on the powder at the top of the hopper, such as due to vibrations, will normally reduce the flowability of the hopper by wedging the powder into the converging shape. Vibration, impact or higher vertical load on the powder improves the flowability of powder in preferred embodiments of the present invention. This is an advantage since the natural response of operators when faced with flow problems in a hopper is usually to impact or vibrate the hopper.

It is expected that one of the most useful applications of embodiments of the present invention will be to discharge powders from FIBCs. The lower section, which may be made of flexible material, is permanently attached to the underside of an FIBC. Before filling, storage and transport, the lower section is folded and temporarily secured. When the powder is required to be discharged, the lower section is unsecured from its temporary folded position and allowed to fall into its lowered position and fill with powder, which may then be discharged.

The description and drawings show embodiments of the invention with an outlet section located to the side of the main body of the container vessel. This provides easy access to the control valve and discharge into some types of equipment but a centrally located outlet with discharger surfaces on each side of the outlet are understood to be a within the scope of the present invention. In addition, it is understood that a discharger surface made up of a number of straight sections joined end-to-end and angled relative to one another is also within the scope of the present invention. In addition, the sidewalls of the lower section may diverge upwardly to increase the volume of the discharger in some applications.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A discharger for a powder, the discharger comprising a hopper and an outlet, the hopper comprising a discharging surface over which, in use, a powder flows, and means for lowering the angle of internal friction of the powder or for lowering the angle of sliding friction between the powder and the full discharger surface, wherein the discharging surface comprises surfaces at of at least two angles that are progressively shallower towards the outlet and in which a steeper part of the discharging surface in use is steeper than 40° from the horizontal.

2. A discharger according to claim 1, in which the discharger surface is steeper than 45° from the horizontal.

3. A discharger according to claim 2, in which the discharger surface is steeper than 50° from the horizontal.

4. A discharger according to claim 3, in which the discharger surface is steeper than 60° from the horizontal.

5. A discharger according to claim 1, in which the width of the discharger surface is less than 30% of its length.

6. A discharger according to claim 1, in which the discharger surface is curved from the back to the outlet.

7. A discharger according to claim 1, In which there is provided means for lowering the angle of internal friction and for lowering the angle of sliding friction between the powder and the discharger surface, in which means the discharger surface comprises a gas permeable membrane and means for passing a gas through the gas permeable membrane.

8. A discharger according to claim 7, in which the gas permeable member comprises a flexible bag.

9. A discharger according to claim 7, in which means is provided to pass a gas through a powder from beneath.

10. A discharger according to claim 9, in which the discharger is adopted to pass gas through a powder adjacent to the outlet.

11. A discharger according to claim 1, in which there is provided means for lowering the angle of internal friction and for lowering the angle of sliding friction between the powder and the discharger surface, which comprises a vibrator for vibrating the discharger surface.

12. A discharger according to claim 1, in which the discharger further comprises a front wall adjacent the outlet, which front wall slopes inwardly towards the hopper as it extends to the outlet.

13. A discharger according to claim 12, in which the inward slope is substantially 10° from the vertical.

14. A discharger according to claim 1, in which the discharger surface is curved across the discharger surface.

15. A discharge according to claim 14, in which the curve is generally a U-shape.

16. A discharger according to claim 1, in which the discharger comprises side walls at least one of which diverges as it approaches the outlet.

17. A discharger according to claim 1, in which at least one internal ridge is provided extending from a side wall.

18. A discharger according to claim 17, in which the at least one ridge extends in a direction toward the outlet.

19. A discharger according to claim 1, in which the outlet is at the side of the discharger.

20. A method of use of a discharger according to claim 1, the method comprising discharging a powder through the outlet.
